(19) United States
(12) Patent Application Publication
(10) Pub. No.: US 2014/0048068 A1
(43) Pub. Date: Feb. 20, 2014

(54) UNDERWATER TANK MONITORING AND COMMUNICATION APPARATAUS, METHODS AND SYSTEMS

(71) Applicant: Liquivision Products, Inc., Burnaby (CA)

(72) Inventor: Eric Abdel FATTAH, Burnaby (CA)

(73) Assignee: Liquivision Products, Inc., Burnaby (CA)

(21) Appl. No.: 13/966,068

(22) Filed: Aug. 13, 2013

Related U.S. Application Data
(60) Provisional application No. 61/682,986, filed on Aug. 14, 2012.

(51) Int. Cl. A62B 9/00; B63C 11/26; B63C 11/22

(52) U.S. Cl. CPC A62B 9/006; B63C 11/2209; B63C 11/26
USPC 128/204.21; 128/205.23

(57) ABSTRACT

Transmitter and receiver devices and related methods are provided for monitoring air supplies and optionally directions of a group of divers. A transmitter device includes an acoustic transmitter, and may have a housing with two nonconcentric generally cylindrical portions of different diameters. The transmitter device may send brief sonic data packets comprising pressure, identification and error checking portions encoded with an on/off modulation scheme. A receiver device decodes sonic packets received from a transmitter device, and may include a plurality of acoustic transducers for determining a direction of a transmitter device. Both the transmitter and receiver devices may be compact, low cost and have long battery life.

### CROSS REFERENCE TO RELATED APPLICATION

This application claims the benefit of priority under 35 U.S.C. §119 of U.S. Provisional Patent Application No. 61/682,986 filed Aug. 14, 2012 and entitled UNDERWATER TANK MONITORING AND COMMUNICATION APPARATUS, METHODS AND SYSTEMS, which is incorporated herein by reference in its entirety.

### FIELD

The present disclosure relates generally to monitoring of scuba divers. More particularly, the present disclosure relates to monitoring and communicating a diver's air supply and optionally determining the diver's location.

### BACKGROUND

When diving underwater, scuba divers breathe from a tank containing compressed gas mixtures. The pressure in the tank gives an indication of how much longer the diver can remain underwater before the gas supply runs out. Historically, divers would use an analog pressure gauge connected to the tank to monitor the gas pressure in the tank. More recently, radio transmitters have become available, as disclosed, for example in U.S. Pat. No. 5,392,771. In this case, a compact device is screwed onto the tank, which digitally measures the tank pressure and transmits it to the computer sitting on the diver's wrist. This is somewhat more comfortable and convenient to the diver, and it allows the dive computer to monitor the rate of change of the gas pressure to estimate quite accurately how much longer the diver can remain underwater before the gas supply runs out.

Scuba divers breathe various gas mixtures, containing oxygen, helium and nitrogen. For simplicity, all such mixtures will be referred to as ‘air’ and the supply thereof as the ‘air supply’ or ‘gas supply.’

Typically, scuba divers do not dive alone, but dive either in pairs, or in groups. In the case of a pair of divers, each diver has a desire to know the gas supply of the other diver. Typically one diver will run out of air before the other, and at that moment both divers must surface at the same time. Currently the only way divers can communicate their gas supply to each other is by visual hand signals, or by swimming directly up to the other diver and manually checking either their analog pressure gauge or their wrist computer (in the case that the diver is using a radio transmitter). To convey visual signals, the two divers must be in visible range of each other. To swim up to the other diver (to check their gauges) requires knowing where the other diver is located. In the case of cloudy water or unanticipated problems, divers can be separated and their respective locations may be unknown. Underwater diver-to-diver voice communication systems exist. Using such a system it is possible for one diver to simply tell the other one how much air he has left. However, such systems are expensive, complicated, and limited to commercial and military divers. They do not allow the location of a diver to be determined when out of visible range.

A low cost, mass market means of remotely monitoring another diver's gas pressure is needed. Further, if the diver is out of visible range, a means of locating him is also highly desirable.

Often, scuba divers will dive in groups. In the case of a scuba diving course, one instructor will instruct up to eight students. On a tour boat, one dive guide will take up to eight divers on a guided tour from a boat owned by the tour company. In both cases, there is one experienced diver (the instructor or tour guide), paired with up to eight possibly inexperienced divers. The inexperienced divers often feel a false sense of security due to the presence of the instructor or dive guide. Inexperienced divers will often wander away from the group and forget to monitor their gas supply. In other cases, problems with the gas pressure monitoring equipment may result in a gas pressure reading which does not change with time. This type of anomaly will be clearly recognized by the experienced instructor or dive guide, but may not be seen as a problem by an inexperienced diver. Hundreds of divers die each year while diving in similar group scenarios. If the dive guide or instructor had a means to remotely and simultaneously monitor the air supply of each and every diver in the group, and as well locate any diver who wanders out of visible range, hundreds of deaths could be prevented each year. In a typical open water diving situation, a diver could wander up to 200 m away from the dive guide.

One obvious approach would be to use a radio transmitter. As disclosed for example in U.S. Pat. No. 5,392,771. However, underwater radio transmitters practical for scuba divers have extremely short range due to the attenuation of radio waves by the conductive sea water. Long range underwater radio transmission is only possible with enormously long antennas, which are impractical for a scuba diver. The strict size requirements of scuba diving gear means that only short antennas are possible. As a result, existing wireless tank pressure transmitters generally have a range of less than 2 m (6 ft). This means that the range is only long enough to transmit from the diver's own tank to another device carried by the diver (e.g. a device on his or her own wrist); no radio communication from one diver to another is typically possible. Further, electrical interference from strobe lights and other electrical equipment used by divers is known to interfere with these weak, low frequency radio transmitters, causing intermittent loss of signal. For these reasons, underwater radio transmitters cannot be used to remotely monitor the gas pressure of other divers, and similarly cannot be used to locate other divers.

It is well known that the most favorable method of wireless underwater communication is done by acoustic means. Sound travels extremely well underwater, and can be encoded to contain data. Scuba divers are sometimes seen using full face masks equipped with wireless voice communication systems. These communication systems rely on ultrasonic sound waves to transfer encoded voice from one diver to another, or to a receiving station on the surface. Unfortunately, existing ultrasonic communication systems are typically bulky and expensive.

A scuba diving tank is equipped with a 1st stage regulator device. This device contains several low pressure ports (which, via hoses, lead to the mouthpiece, buoyancy vest and/or drysuit). The first stage regulator also contains several high pressure ports, to which analog pressure gauges or radio transmitters are connected. Numerous companies manufacture these first stage regulators, and the size of these regulators and the locations of their pressure ports impose constraints on the size of any device connected to them.

Examples of prior art related to underwater monitoring and communications include the following US patents:
U.S. Pat. No. 6,762,678;
U.S. Pat. No. 6,272,072;
U.S. Pat. No. 5,570,323;
U.S. Pat. No. 5,392,771;
U.S. Pat. No. 8,159,903;
U.S. Pat. No. 8,094,518;
U.S. Pat. No. 8,091,422;
U.S. Pat. No. 8,009,516;
U.S. Pat. No. 7,512,036;
U.S. Pat. No. 7,642,919;
U.S. Pat. No. 7,612,686;
U.S. Pat. No. 7,483,337;
U.S. Pat. No. 7,388,512;
U.S. Pat. No. 7,310,286;
U.S. Pat. No. 7,304,911;
U.S. Pat. No. 7,272,075;
U.S. Pat. No. 7,187,622;
U.S. Pat. No. 7,006,407;
U.S. Pat. No. 6,941,226;
U.S. Pat. No. 6,931,339;
U.S. Pat. No. 6,272,073;
U.S. Pat. No. 6,130,859;
U.S. Pat. No. 6,125,080;
U.S. Pat. No. 5,956,291;
U.S. Pat. No. 5,784,339;
U.S. Pat. No. 5,666,326;
U.S. Pat. No. 5,523,982;
U.S. Pat. No. 5,331,602; and
U.S. Pat. No. 3,986,161

The inventor has determined a need for a compact device which can remotely monitor the gas pressures of other divers. The inventor has determined a need for devices which may be used to locate those same divers if they are out of visible range. The inventor has determined a particular need for such devices which are low cost, compact, simple to use, have extended ranges (e.g. up to 200 m or more) and do not require a full face mask.

### SUMMARY

One aspect provides an apparatus comprising a housing having a connector configured to connect to a first stage regulator, the housing having a size and shape configured to provide clearance for one or more hoses connected to the first stage regulator, a pressure sensor within the housing, the pressure sensor coupled to receive a measured pressure through the connector and configured to generate a pressure indication based on the measured pressure, a transducer within the housing, the transducer configured to convert electrical signals into vibration signals, a power pack within the housing, the power pack configured to connect across a battery to receive a battery voltage, the power pack comprising at least one excitation capacitor selectively connectable to the transducer and configured to provide an excitation voltage to the transducer, the excitation voltage being significantly higher than the battery voltage, and a controller connected to receive the pressure indication from the pressure sensor and control the power pack to charge the at least one excitation capacitor and discharge the at least one excitation capacitor to provide excitation pulses to the transducer, the excitation pulses configured to cause the transducer to generate a sonic data packet based on the pressure indication.

Another aspect provides an apparatus comprising a housing having a first generally cylindrical portion of a first diameter and a second generally cylindrical portion of a second diameter larger than the first diameter, the first and second generally cylindrical portions being nonconcentric with each other, a generally cylindrical battery compartment within the housing and extending through at least a portion of each of the first and second generally cylindrical portions of the housing, a connector coupled to the housing, the connector configured to connect to a first stage regulator, a pressure sensor within the housing, the pressure sensor coupled to receive a measured pressure through the connector and configured to generate a pressure indication based on the measured pressure, a transducer within the housing, the transducer positioned in the first generally cylindrical portion of the housing and configured to convert electrical signals into acoustic signals, a power pack within the housing, the power pack positioned in the second generally cylindrical portion and configured to connect across a battery in the battery compartment to receive a battery voltage and provide an excitation voltage to the transducer, the excitation voltage being significantly higher than the battery voltage, and a controller connected to receive the pressure indication from the pressure sensor and control the power pack to provide excitation pulses to the transducer, the excitation pulses configured to cause the transducer to generate acoustic signals based on the pressure indication.

Another aspect provides an apparatus comprising a plurality of transducers, each transducer configured to detect an underwater acoustic signal and generate an electrical signal in response thereto, and, a controller connected to receive the electrical signal from each of the plurality of transducers and determine a direction of a source of the underwater acoustic signal based on a time of receipt of the electrical signal from each of the plurality of transducers and a known spatial relationship among the plurality of transducers.

Another aspect provides a method for monitoring a group of divers, the method comprising providing a plurality of transmitter devices, each transmitter device connected to receive a tank pressure from a first stage regulator of one diver of the group of divers, each transmitter device comprising a transmitting transducer configured to generate acoustic signals at a transmitting frequency, providing a receiver device comprising at least one receiving transducer configured to detect acoustic signals having the transmitting frequency, at each of the transmitter devices, generating a plurality of sonic data packets with a time between sonic data packets being significantly longer than a duration of each of the plurality of sonic data packets, each sonic data packet comprising at least an identification portion and a pressure indicating portion, at the receiver device, receiving the sonic data packets and determining a remaining air supply for each diver of the group of divers.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 shows a group of scuba divers equipped with transmitter devices and a receiver device according to one embodiment.

FIG. 2 shows an example transmitter device attached to a first stage regulator of a scuba tank according to one embodiment.

FIG. 3 shows an example transmitter device in isolation.

FIG. 4 shows an example transmitter device with the housing depicted transparently to show the internal components of the device.

FIG. 5 is a perspective view of the transmitting transducer of the device of FIG. 4 in isolation.

FIG. 5A is a side view of the transmitting transducer of FIG. 5 schematically illustrating the projection of sound from the transmitting transducer.

FIG. 6 shows an example receiver device according to one embodiment.

FIG. 7 shows a receiving transducer of the device of FIG. 6 in isolation.

FIG. 7A is a sectional side view of the receiving transducer of FIG. 7.

FIG. 8 is a block diagram schematically illustrating example circuit elements for a transmitter device according to one embodiment.

FIG. 9 is a circuit diagram of an example transmitter circuit for a transmitter device according to one embodiment.

FIG. 10 is a timing diagram schematically illustrating example operation of the circuit of FIG. 9.

FIG. 11 shows example graphs of transmitting transducer excitation voltage and the resulting transmitting transducer sonic output over time.

FIG. 12 schematically illustrates an example sonic data packet, as well as graphs of the corresponding transmitting transducer excitation voltage, transmitting transducer sonic output and receiving transducer signal over time for the start byte of the example sonic data packet.

FIG. 13 is a timing diagram schematically illustrating sonic data packets received by a receiver device from a plurality of transmitting devices according to one embodiment.

FIG. 14 is a circuit diagram of an example receiver circuit for a receiver device according to one embodiment.

FIG. 15 is a circuit diagram of another example receiver circuit for a receiver device according to one embodiment.

FIG. 16 is a circuit diagram of another example receiver circuit for a receiver device according to one embodiment.

### DETAILED DESCRIPTION

The present disclosure provides transmitters, receivers and related methods for underwater communication. In example embodiments described herein, the transmitter comprises a compact housing which connects to the first stage regulator of a scuba diving tank, either by screwing it directly into the first stage, or by connecting it via a high pressure hose. In embodiments configured for connection to a first stage regulator by a hose, the transmitter may have any suitable shape and size, although compact transmitters are generally preferred. In embodiments configured for direct connection to a first stage regulator, in order for the transmitter to be screwed onto most typical first stage regulators the transmitter must fit within a cylindrical volume having a diameter of 41 mm or less. Certain embodiments which are configured to connect directly to a first stage regulator comprise a housing having two generally cylindrical sections which are not concentric with each other. The transmitter housing contains a pressure sensor which measures the gas pressure in the tank, and a transducer which transmits the tank pressure wirelessly via sound waves to the receiver device. The acoustic transmission sent by the transmitter device may also contain a transmitter link code or transmitter ID to differentiate one transmitter from another. The transmission may also contain information relating to the battery level in the transmitter itself. The transmission may also contain various error checking values, including a start byte, end byte and/or checksum.

In example embodiments described herein, the receiver device contains hardware required to receive and decode the acoustic signal. The receiver device also contains a display device, and possibly other peripherals commonly found in diving computers. The receiver device can be mounted in numerous ways, such as on the wrist, inside the diver's mask, or suspended from the diver's vest. The receiver device receives the acoustic transmissions, decodes and displays the received data, and also calculates the source direction of the transmission to locate the direction of the diver from where the transmission originated. The receiver device may also contain a digital compass to facilitate navigating in the direction where the transmission originated. Any number of receiver devices can exist underwater and will pick up all the transmitted signals from every transmitter device. Multiple transmitters may also exist underwater and the device includes a data modulation scheme which allows simultaneous operation of multiple transmitters. Both the receiver and transmitter contain a battery as a source of electrical power.

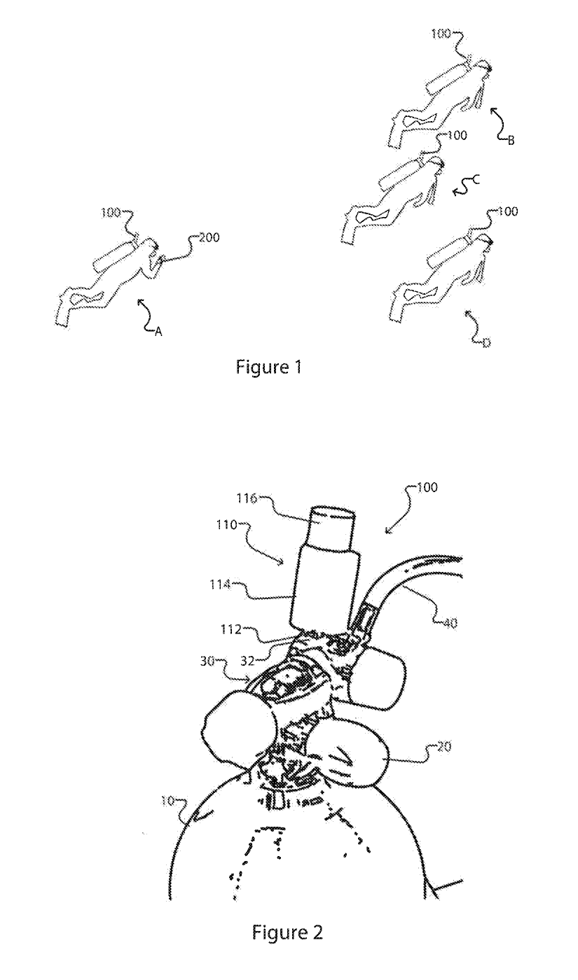

FIG. 1 illustrates an example of four divers A-D provided with transmitting devices 100 according to one embodiment. A transmitting device 100 is connected directly the first stage regulator of each diver's tank. In the illustrated example, diver A also has a receiver device 200, whereas divers B, C, and D only have a transmitting device. Receiver device 200 is shown as coupled to diver A's wrist, but it is to be understood that receiver device 200 could be handheld or mounted at any other convenient location on a diver. Also, only one receiver device 200 is shown in the FIG. 1 example, but it is to be understood that more than one diver in a group of divers may be equipped with a receiver device 200. By means of receiver device 200, a diver can monitor both his own air supply, and the air supply of multiple other divers equipped with transmitter devices 100 located a great distance away. In some embodiments, transmitter devices 100 may reliably provide signals to a receiver device up to 200 m or farther away, for example. Also, in some embodiments, receiver device 200 may be configured to locate any divers equipped with a transmitter device 100 within such range even if they are not within visible range.

In currently preferred embodiments, transmitter device 100 is mechanically compatible with existing mass-marketed first stage scuba diving regulators, achieves long battery life, despite its compact size, and is extremely inexpensive to manufacture. Likewise, currently preferred embodiments of receiver device 200 also have long battery life and low manufacturing costs.

Industry standard first stage scuba regulators impose size constraints on transmitter device 100. In order to screw into existing high pressure ports on such regulators, transmitter device 100 has an outside diameter of no more than 41 mm. Transmitter device 100 also preferably has a length of less than about 90 mm, otherwise it would protrude in an unsafe fashion from the diver's tank.

FIG. 2 shows an example tank 10, which is connected by a valve 20 to a first stage pressure regulator 30. Regulator 30 provides a reduced pressure to hose 40, which may, for example be connected to a diver's vest or mouthpiece (not shown). Regulator 30 also has a high pressure port 32, to which transmitter device 100 is connected. Device 100 comprises a housing 110 having a connector 112 at one end thereof, which may be referred to herein for convenience as the “bottom” end. As used herein, the terms “bottom” and “top” (and related directional terms) are used to refer to the directions toward and away from connector 112, rather than to relative elevations.

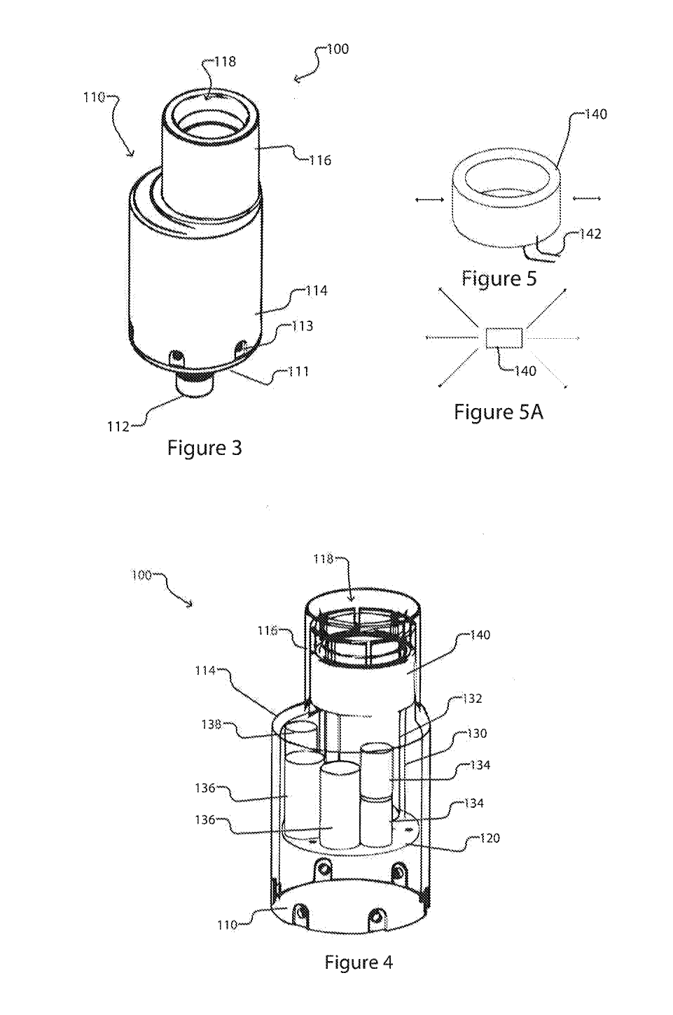

FIG. 3 shows the exterior of device 100 in somewhat greater detail. In the illustrated example, housing 110 comprises a larger generally cylindrical portion 114 and a smaller generally cylindrical portion 116 sized to accommodate the internal components of device 100 as described below. As used herein, the term “generally cylindrical” is used to refer to shapes that fit within a volume defined by a right circular cylinder, but are not necessarily strictly cylindrical.

As shown in FIG. 3, connector 112 may be coupled to a bottom section 111 which is attached to the rest of housing 110 by suitable fasteners 113 (e.g., bolts, screws or the like). Sealing means such as, for example, an O-ring (not shown) may be provided between bottom section 111 and the rest of housing 110. In some embodiments, connector is made from metal, and bottom section 111 and the rest of housing 110 are made from plastic. Housing 110 may have a battery access opening 118 at the top end thereof to permit access to insert and remove a battery from a battery compartment 130 (not shown in FIG. 3, see FIG. 4). Opening 118 may be covered by a battery cap (not shown) which comprises threads for engaging corresponding threads on the inner surface of opening 118, such that the battery cap can be screwed into opening 118 to seal battery compartment 130.

Underwater transmission of sound requires relatively high voltages to achieve acceptable ranges. To achieve the required change of several hundred meters, a transducer such as a typical ring transducer must be excited by a square wave of between 100V and 200V. Even higher voltages are possible (300-1000V) and will increase the range further, at the cost of reduced battery life. Generating such a high voltage from a small battery is complicated, and requires a large inductor and one or more large capacitors. Fitting the pressure transducer, the electronic circuit board, the battery, the large inductors and capacitors, all into a housing that is less than 41 mm in diameter and 90 mm in length is a major challenge.

Prior art tank pressure transmitters are typically radio frequency based and sized to fit into a cylindrical housing. The cylindrical battery slides into the housing, and the entire housing is rotationally symmetric about a longitudinal axis. Some embodiments may be implemented using such a symmetrical arrangement. However, using a symmetrical arrangement leaves only limited room for the inductor and capacitor(s). Accordingly, certain embodiments provide an alternative arrangement where the battery is housed in a generally cylindrical compartment which is not concentric with a larger generally cylindrical portion of the housing. This non-concentric design allows the capacitors and inductor to be placed beside the battery compartment. Other non-symmetrical arrangements are also possible.

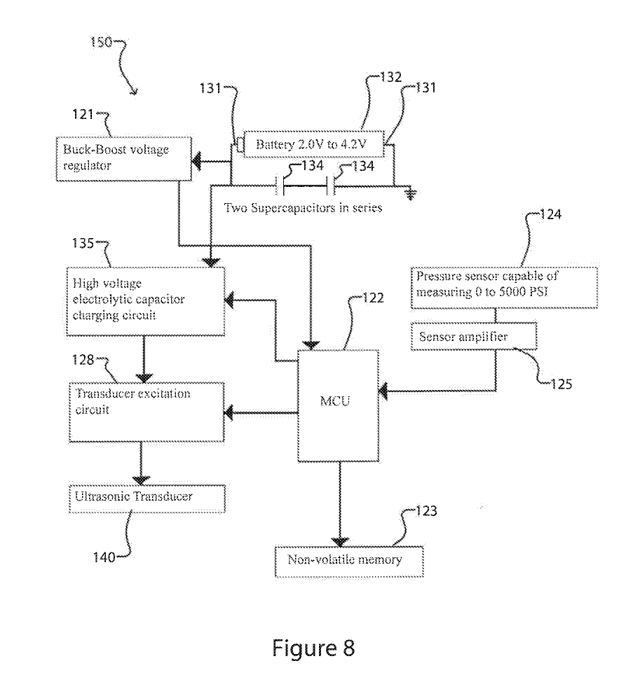

As shown in FIG. 4, a battery compartment 130 within housing is sized to receive a cylindrical battery 132, which extends from smaller generally cylindrical portion 116 down into larger generally cylindrical portion 114 of housing 110. Larger generally cylindrical portion 114 of housing 110 is not concentric with smaller generally cylindrical portion 116 to provide space for a power pack configured to receive battery voltage and generate a much higher voltage for exciting an acoustic transducer, as described below. In the illustrated example, the power pack comprises two supercapacitors 134 (e.g., electrochemical double layer capacitors), two high voltage electrolytic capacitors 136, and a high current inductor 138 having a low equivalent series resistance (ESR), but it is to be understood that the power pack could comprise a different combination of elements in other embodiments. For example, in some embodiments, instead of being eletrolytic, high voltage capacitors 136 may be ceramic or other solid dielectric capacitors, polymer capacitors, or other types of capacitors. A printed circuit board 120 is also provided within larger generally cylindrical portion 114. Below circuit board 120, space is provided for bottom section 111 and connector 112 to extend partially into and overlap with larger generally cylindrical portion 114, as well as for a pressure sensor 124 (not shown in FIG. 4, see FIG. 8) connected by wires to board 120 and positioned to be exposed to pressure received through connector 112. A ring transducer 140 is located within smaller generally cylindrical portion 116 on the outside of battery compartment 130.

As shown in FIG. 5, ring transducer 140 has electrical wires 142 connected (e.g. soldered) to the inner and outer surfaces thereof. Ring transducer 140 expands and contracts radially by an amount dependent on a voltage difference applied to the inner and outer surfaces. As shown by the arrows in FIG. 5A, ring transducer 140 projects sound almost omni-directionally. There is only a small dead-band along the cylindrical axis of the ring of transducer 140. The expansion and contraction of ring transducer 140 must directly push the water outside housing 110. Thus, smaller generally cylindrical portion 116 of housing 110 is configured such that ring transducer 140 is surrounded by only a thin layer of material and is thus directly coupled to the surrounding water. If ring transducer 140 were placed outside the capacitors 134, 136 and inductor 138, this would increase the outside diameter of housing 110, most likely beyond the limit of 41 mm if components capable of long range transmission are used. For this reason, ring transducer 140 is placed outside the battery but above the capacitors 134, 136 and inductor 138, as shown in FIG. 4.

An acoustic transducer can be used both as a projector (to transmit sound) as well as a receiver or ‘hydrophone’ (to receive sound signals). Due to the high voltages required to transmit sound, and the extremely low voltages involved in receiving sound, using the same transducer to transmit and receive is exceedingly complicated and expensive from a standpoint of the electronics required. To achieve the lowest cost and complexity, certain embodiments provide a one directional communication system wherein the transmitter device 100 only transmits, and the receiver device 200 only receives. The transmitter device 100 thus requires only transmission electronics. The receiver device 200 requires only receiving electronics. While this results in simpler and lower cost electronics, it requires an innovative modulation scheme to allow multiple transmitters, as described further below.

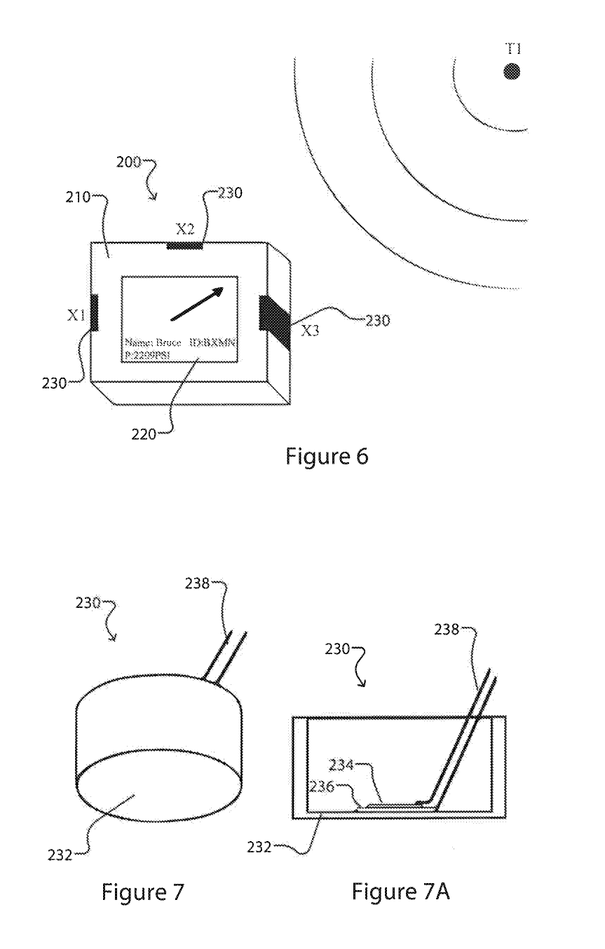

FIG. 6 shows an example embodiment of receiver device 200. In the illustrated example, receiver device 200 comprises a housing 210, a display 220 and three receiver transducers 230 (individually labeled X1 X2 X3). The example of FIG. 6 includes three receiver transducers 230, but a receiver requires only one transducer to simply receive the tank pressure acoustic signals sent by transmitter device(s) 100. In order to calculate the direction of the source of the signal, two or more (typically two to four) transducers are used in the receiver. Adding transducers and their associated electronics increases the cost of receiver device 200. Thus, the least expensive embodiment utilizes only one transducer 230 in the receiver device 200 and is incapable of calculating the direction of the signal. A slightly more expensive embodiment uses two to four transducers 230 in the receiver device 200, allowing it to calculate the direction of the signal source. With multiple transducers 230 in the receiver device 200, the incoming sound wave from the transmitter will strike the different receiver transducers at different times, due to the finite propagation speed of the sound in water. The receiver electronics can detect the time differential between the sound striking one transducer, versus striking another, as will be shown in more detail later.

As shown in FIG. 6, a transmitter T1 emits sound waves, which strike receiver transducers X2 and X3 first, and X1 later. Electronics within receiver device 200 calculate the phase shift between the signals received on the various transducers, allowing the direction to the source to be calculated and displayed on the display 220 as shown. The transmitted data is decoded, and the transmitter ID and associated tank pressure are displayed. For ease of reading, the receiver device 200 allows the user to associate a name with the transmitter ID, such that whenever a signal is received from that ID, the associated name is displayed instead of or along with the actual ID. The ID code is typically numerical, but can be encoded as a series of alphanumeric characters to shorten the length of the actual number.

The resonant frequency of the transmitter's transducer and the resonant frequency of the receiver's transducer(s) are selected to be very close to one another. The resonant frequency of the transducers may generally be in the range of about 20 KHz to 80 KHz. Below about 20 KHz the data rate is so slow that not many transmitters can be used simultaneously due to collision of packets, as discussed below. Above about 80 KHz the sound attenuates faster, requiring even higher voltages. Also, higher frequency transducers require a higher A/D sampling frequency, faster microcontrollers and more RAM, as discussed below. In some embodiments the resonant frequency of the transducers may generally be in the range of about 40 KHz to 50 KHz. In a prototype embodiment, the resonant frequency of the transducers is about 43 KHz.

In some embodiments, identical ring transducers, as shown in FIG. 5, are used in both the transmitter and receiver devices 100 and 200. A more compact embodiment utilizes piezo bender style transducers in the receiver, such as transducer 230 shown in FIGS. 7 and 7A. These transducers have the advantage that they are mass produced for automatic parking devices, and cost under $1. Transducer 230 consists of a hollow cylindrical aluminum housing 232, inside of which a small piezo bender is glued. The piezo bender consists of a brass disk 236, onto which another smaller ceramic disk 234 is bonded. Wires 238 connect to the ceramic and the brass disks. The inside of the housing 232 can be hermetically sealed and filled with air; alternatively the housing 232 can be potted with a soft potting material such as a silicone or polyurethane.

In some embodiments, the receiver device 200 is filled with a soft potting material in which the speed of sound is very similar to that of water. Two to four piezo bender transducers such as transducer 230 are included in the receiver device 200, themselves also without airspace but potted with a soft material, possibly the same material as in the receiver housing 210. In this fashion, sound travels through the surrounding water, into the housing 210 of the receiver device 200, and through the receiving transducers 230, without ever contacting air. In such embodiments, the entire receiver is essentially transparent to sound, and no air/water interfaces will reflect or distort the sound. The walls of the housing 210 and the display 220 may cause minor reflections and minor attenuation, but not as much as an air/water interface. Also, to locate other divers, the receiver device 200 is typically held ‘flat’ (e.g. parallel to the surface of the water), thus the sound does not pass directly through the display 220. Air filled piezo bender transducers are directional in their sensitivity; potted piezo bender transducers are omni-directional in their sensitivity. This potted embodiment improves the accuracy of the directional calculation when ascertaining the source of a sound signal by means of the time differential or phase shift between the sound signals striking the respective receiver transducers.

FIG. 8 shows an example circuit 150 for controlling transmitter device 100. The circuit 150 is controlled by a central microcontroller (MCU) 122. A pressure sensor 124 inside the transmitter device 100 converts the pressure in the diver's tank (which may be received through connector 112 directly from the regulator or from a hose connected thereto) to an electrical signal which is amplified by a sensor amplifier 125 and fed into the microcontroller 122. In some embodiments sensor amplifier 125 also digitizes the signal from pressure sensor 124. Pressure sensor calibration coefficients, a transmitter link code, serial number and any other necessary non-volatile information are stored in a non-volatile memory device 123 accessible by microcontroller 122. A compact battery 132 may, for example, provide between about 2.0V and 4.2V. The battery voltage is fed into a voltage regulator 121, typically a low-dropout type or optionally a buck-boost regulator, to provide a fixed voltage to the rest of the circuit 150. If the battery 132 has a high internal impedance, a string of supercapacitors 134 are connected in parallel to the battery 132 to lower the apparent impedance. A capacitor charging circuit 135 boosts the battery voltage (typically 2.0V to 4.2V) up to 100V-200V or more and stores this energy in high voltage electrolytic capacitors (e.g., capacitors 136 of FIG. 4) or a similar storage device. The microcontroller 122, having digitized the tank pressure, encodes the data into a data packet, and channels the high voltage electrical energy stored in the electrolytic capacitors to the acoustic transducer (e.g. transducer 140 of FIG. 4) by means of a transducer excitation circuit 128.

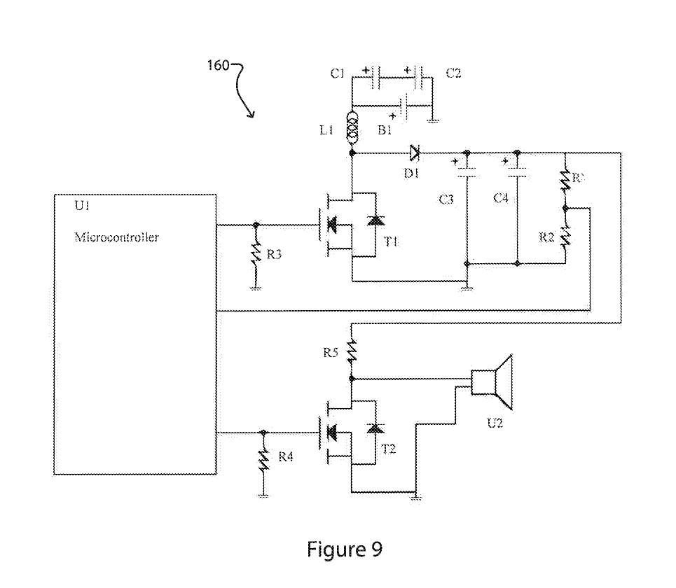

FIG. 9 shows another, more detailed, example circuit 160 for controlling transmitter device 100. The example of FIG. 9 includes the capacitor charging circuit and transducer excitation circuit in greater detail, but omits the pressure sensor, sensor amplifier, memory and voltage regulator for ease of illustration. In order to generate the several hundred volts required, a current of approximately 2 amperes is required from the battery B1. If the battery B1 has a high internal impedance, it will not be capable of generating this amount of current, and in this case two supercapacitors C1 and C2 are connected in parallel with the battery. If the battery voltage is 2.0V to 4.2V, then two 1.0 F 2.5V supercapacitors connected in series allow up to 5.0V of battery voltage. A high voltage transistor T1 is connected to the microcontroller U1. The microcontroller U1 applies a high logic value to the gate of the transistor T1, essentially closing the path from inductor L1 to ground. At this moment, current rushes from the battery B1 and/or supercapacitors C1 and C2, through the inductor L1 into ground. This state is continued until the inductor L1 reaches is saturation current. This process essentially converts the electrical energy stored in the battery B1 and/or supercapacitors C1 and C2 to magnetic field energy in the inductor L1. The microcontroller U1 then drops the T1 gate voltage to 0V, opening the T1 switch. The magnetic field in the inductor L1 collapses, forcing a small current with an extremely high voltage through diode rectifier D1, and into parallel high voltage electrolytic capacitors C3 and C4, which store charges to accumulate a high voltage. For transmission at 200V, two 22 uF electrolytic capacitors C3 and C4 each rated for at least 200V are sufficient. A resistive divider R1/R2 drops the high voltage across the capacitors C3 and C4 into a very low voltage suitable for detection and digitization by the microcontroller U1. In this fashion the microcontroller U1 can detect the voltage currently stored in the capacitors C3 and C4. The microcontroller U1 repeatedly opens and closes transistor T1, repeating the process, and each time the capacitors C3 and C4 are charged to a higher and higher voltage. When the microcontroller U1 determines (by means of digitizing the signal from the resistive divider R1/R2) that the voltage on capacitors C3 and C4 has reached an adequate threshold value at which sufficient energy exists in the capacitors for a single brief acoustic transmission, the charging process is terminated. The number of on/off cycles applied to the transistor T1 is controlled such that the supercapacitors C1 and C2 are not fully discharged. The desired timing and number of the cycles applied to transistor T1 depends on the impedance of the battery, the size (in farads) of the supercapacitors, the ESR of the inductor and other factors and may, for example, be determined experimentally. In some embodiments, timing of the cycles applied to transistor T1 is determined with an oscilloscope and the timing is then hard-coded into software executable by microcontroller U1, such that no feedback is required. Microcontroller U1 also controls transistor T2 to cause transducer U2 to send sonic signals, as described below.

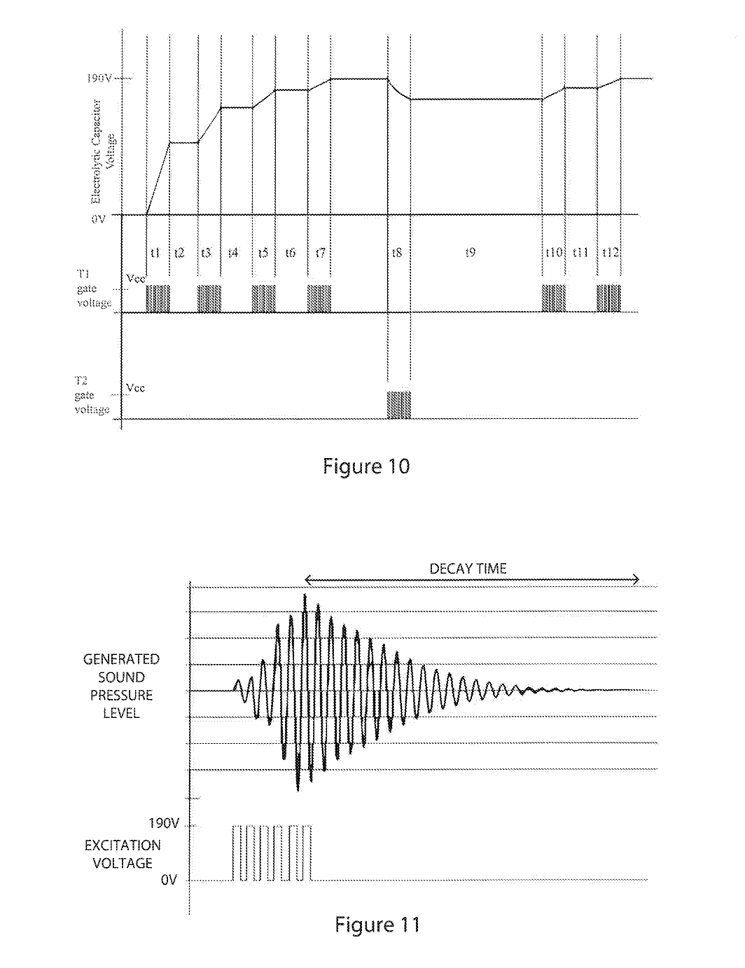

FIG. 10 shows example timings of how microcontroller U1 controls transistors T1 and T2 and the resulting charge on capacitors C3 and C4. During time interval t1, the transistor T1 is turned on and off many times, gradually charging the capacitors C3 and C4. The figure shows that the voltage on the capacitors increases during time interval t1. At the end of t1, the supercapacitors C1 and C2 have largely discharged. The high impedance battery B1 cannot provide sufficient current to continue the process. The transistor T1 is turned off. During time period t2, the system waits for the battery to recharge the supercapacitors. Once the supercapacitors have been charged by the battery, time interval t3 begins and again transistor T1 is cycled on and off, and the energy in the supercapacitors is transferred to the inductor, then to the electrolytic capacitors. As shown in FIG. 10, time periods t2, t4, t6, t11 are periods where the system pauses as the supercapacitors are charged. If a very high quality rechargeable battery is used, the battery may be capable of sufficiently high current that no supercapacitors are necessary, also eliminating the need for time delays t2, t4, t6, t11. However, for lowest cost operation the device is operable with low cost disposable batteries which cannot by themselves provide high enough current without being paired with supercapacitors. Further, disposable high energy lithium batteries (such as lithium thionyl chloride) have much longer life than rechargeable batteries, but their impedance is too high to provide enough current and they must be paired with supercapacitors for the voltage boosting process to be practical.

Once the electrolytic capacitors have been charged to a sufficient voltage, the system can transmit a data packet containing the tank pressure, transmitter link code, and other information. Referring to FIG. 9, the acoustic transducer U2 (e.g. ring transducer 140 of FIGS. 4 and 5) itself has a small capacitance on the order of a few thousand picofarads. The high voltage of capacitors C3 and C4 is applied statically to U2 through a high power resistor R5 on the order of 500 ohms. Transistor T2 remains off (e.g., no voltage is applied to the gate, resulting in an open path). When the time comes to transmit, the microcontroller U1 turns on transistor T2 (e.g., by providing a high logic value to its gate), essentially short circuiting the two terminals of the acoustic transducer U2, causing the large voltage on the transducer U2 to discharge to ground. The microcontroller then turns off transistor T2, and the huge voltage on capacitors C3 and C4 charge up the acoustic transducer U2 back up to the level of the capacitors, through resistor R5. This process is repeated, creating a square wave excitation to the transducer U2 on the order of hundreds of volts. The transducer U2 expands and contracts and emits sound waves as a result. Referring to FIG. 10, the time interval t8 shows the transducer excitation phase. During this phase, as energy is transferred from the high voltage capacitors C3 and C4 to the transducer U2, the capacitor voltage drops (period t8 in FIG. 10). Once the transmission is complete, during period t9 the pressure of the tank is digitized. Period t9 is chosen since electrical noise is a minimum when both transistors T1 and T2 are off. As the time approaches for the next transmission, the capacitors C3 and C4 are charged again during time periods t10 and t12.

Depending on the intricate physical properties of the transducer, a varying number of high voltage pulses may be needed to cause the transducer to vibrate with sufficient amplitude. FIG. 11 shows a situation where six high voltage pulses are applied to the transducer, and the resulting vibration and sound pressure level generated by the transducer are shown.

Referring to FIG. 11, even after the high voltage excitation pulses end, the transducer continues to oscillate and create sound waves, at a gradually diminishing intensity. This period of oscillation after the cessation of excitation is called the decay period, and the length of it is known as the transducer decay time. The decay time is an important factor in the modulation and encoding of the data. The higher the resonant frequency of the transducer, the shorter the decay time of the transducer. Thus, a transducer with a resonant (operational) frequency of 40 KHz will have a shorter decay time than a transducer with a resonant frequency of 20 KHz.

Most previous acoustic communication systems have used frequency or amplitude modulation schemes. The electronics required to encode and decode such modulations are complicated and expensive. To reduce the cost, a simple on/off modulation scheme is used. A sinusoidal acoustic wave of short duration is transmitted to represent a ‘1’ bit. A period of acoustic silence represents a ‘0’ bit. Alternatively, a sinusoidal acoustic wave of short duration may be used to represent a ‘0’ bit and a period of acoustic silence may be used to represents a ‘0’ bit. Due to the decay time of the transducer, achieving acoustic silence after acoustic activity takes some time. Thus, the decay time of the transducer controls the maximum data rate when using the on/off modulation scheme.

To reduce battery power and allow for the maximum number of transmitters, each data packet transmission should be as short as possible. In some embodiments, 56-bit sonic data packets are used.

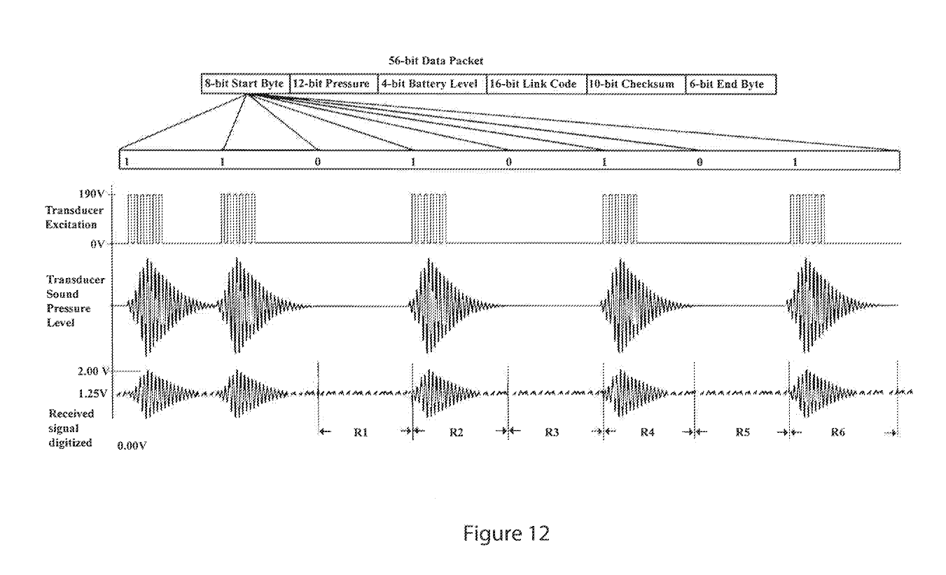

FIG. 12 shows an example 56-bit packet that begins with an 8-bit start byte (binary 11010101), this is followed by a 12-bit tank pressure (representing a pressure from 0 PSI to 5000 PSI). This is followed by a 4-bit battery level (representing 16 levels of battery power), then a 16-bit link code identifying the transmitter (allowing 65536 different transmitter codes). This is followed by a 10-bit checksum, and a 6-bit end byte. From a standpoint of the receiver, the start byte and end bytes must match their known values, and the checksum must match the actual checksum of the pressure, battery level and link code. Otherwise the data is rejected. The above figure shows how the 56-bit data packet is transmitted. One bit is transmitted at a time, this is repeated 56 times, once for each of the 56 bits. For each bit, the transducer is excited with N high voltage pulses, with N typically being between 1 and 20 depending on the transducer. This causes the transducer to oscillate and generate sound. The excitation stops, and the sound pressure level gradually diminishes during the decay time. After a pre-determined and fixed time period, the next bit transmission begins. If the bit is a ‘1’ bit, again the transducer is excited with N high voltage pulses, and allowed to decay. If the bit is a ‘0’ bit, the transducer is not excited at all, and a period of acoustic silence follows. The start byte (11010101) is specifically designed to allow the data to be effectively decoded by the receiver.

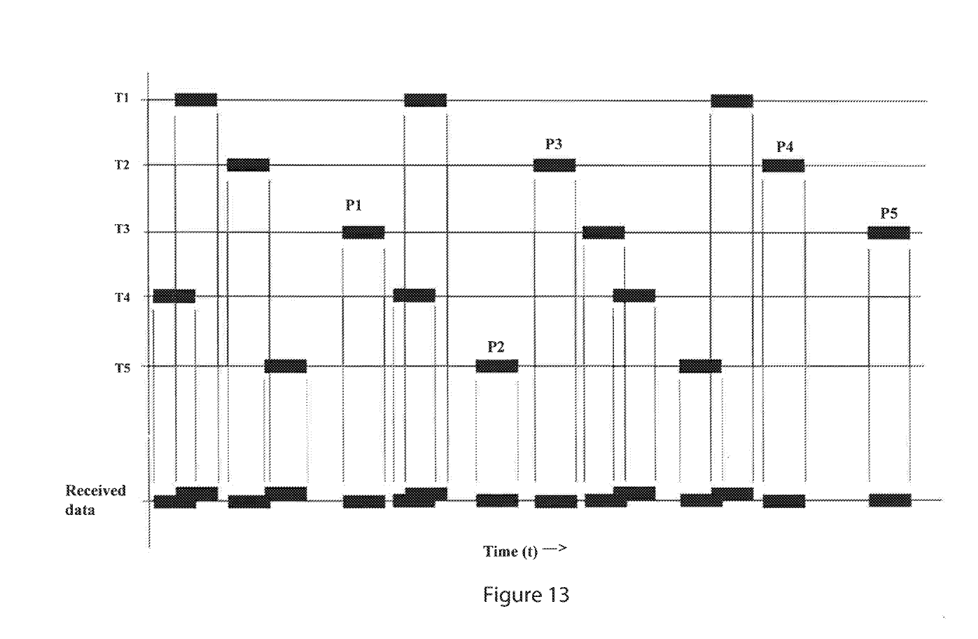

The on/off modulation scheme does not distinguish between sound of different frequencies. Either there is acoustic activity, or there is not. If two transmitters are transmitting at the same time, the data will be corrupted. Referring to FIG. 13, five transmitters (T1 . . . T5) are operating simultaneously. Each transmitter transmits a short packet of data shown by a black bar. The since all the acoustic waves add up on top of each other, the receiver sees the received data stream shown at the bottom. In this case, data packets P1, P2, P3, P4 and P5 reach the receiver without corruption or collision. All the other packets collide with each other and end up corrupted.

Because each transmitter is only capable of transmitting, and each receiver is only capable of receiving, a special scheme is required to minimize data corruption. Three aspects minimize data packet collision. First, the packet length is kept as short as possible (approximately 56 ms for 56 bits at 43 KHz). Second, each transmitter transmits one packet every few seconds (as opposed to continuously). Third, each transmitter randomizes the time in between packets. In a preferred embodiment, each transmitter transmits once every 3000 ms+/−250 ms (i.e. 3000 ms randomized by a random addition from −250 ms to +250 ms). With 10 transmitters in the water all operating simultaneously, statistical analysis and simulation show that any one packet has a 29% chance of being corrupted via a collision with another packet from another transmitter that overlaps. Thus, with 10 transmitters in the water, each packet has a 71% chance of reaching the receiver correctly. Averaging over time, with a transmission occurring every 3 seconds, and 29% of packets being rejected, then approximately 14 packets per minute will reach the receiver correctly. This corresponds to an average tank pressure update rate of once every 4.28 seconds. Similarly, if the signal source is being located, then the arrow directing the diver to the source would be updated once every 4.28 seconds on average. Twenty, thirty or more transmitters can operate simultaneously, but the average data update rate decreases as the number of packet collisions increase.

As discussed above, a receiver device 200 according to some embodiments contains one to four acoustic transducers. The signals from these transducers are amplified, digitized, and then processed by a microcontroller. The digitized stream of data is decoded by the receiving microcontroller, to extract the transmitter link code, the tank pressure value, and the battery level. If the receiver device has multiple transducers, each transducer has its own amplifier. In the case of multiple transducers, various methods can be used to determine the relative phase shift of the signals received on each transducer, to calculate the direction of the signal source.

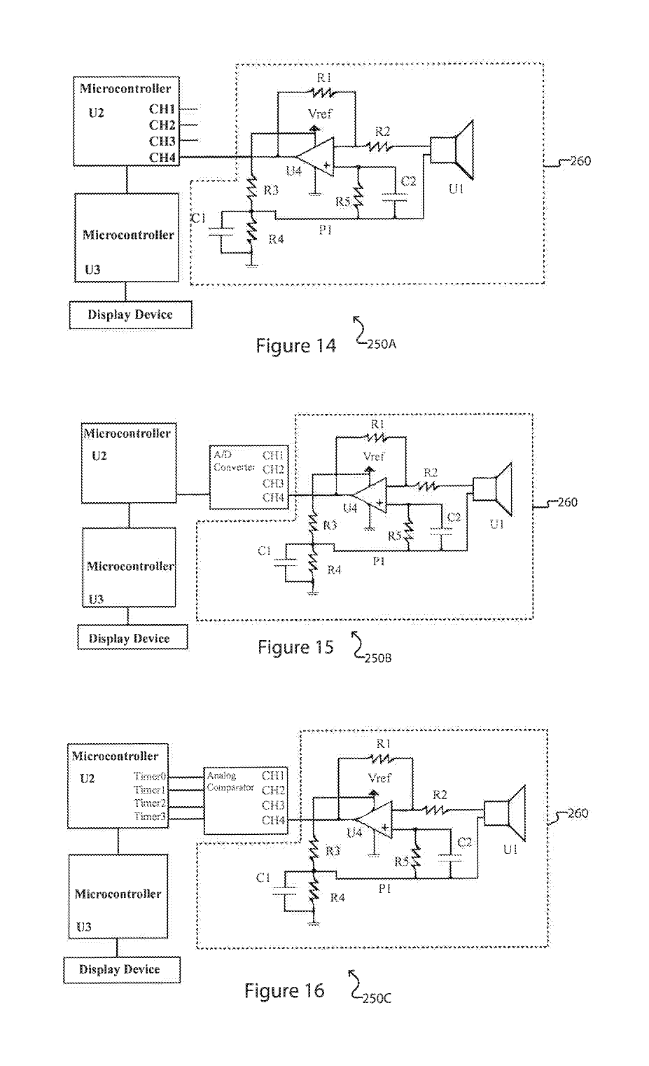

FIGS. 14, 15, 16 show example receiver circuits 250A, 250B, and 250C for a receiver device according to three embodiments. Each of FIGS. 14-16 shows a single receive channel 260 connected to a single receiving transducer (hydrophone) U1. In embodiments with multiple receiver transducers, receive channel 260 may be repeated for each transducer. The electrical signal generated by the transducer U1 in response to sound waves striking it is very small, possibly on the order of a few microvolts. The signal is amplified by an operational amplifier U4 with a high gain-bandwidth product. If the acoustic frequency is, for example, 43 KHz, and the desired gain is 2000, then the gain-bandwidth product of the operational amplifier U4 must be at least 43000 Hz*2000=86,000,000=86 MHz. Further, since the input offset voltage of the amplifier U4 will be multiplied by the gain, an operational amplifier with a low input offset voltage is also desirable. In the example circuits 250A-C, the operational amplifier U4 is set up in an inverting configuration, with resistors R1/R2 determining the gain. To reduce electrical noise, the operational amplifier U4 is not powered by the same voltage regulator as the microcontroller, but rather by a voltage reference Vref, which may, for example, be generated either by a band-gap reference inside the microcontroller or by an external voltage reference. This voltage Vref is cut in half via a resistive divider R3/R4, and the resulting voltage P1 will be half of the Vref value. The voltage P1 is used as a floating or virtual ground for the operational amplifier U4. The acoustic transducer produces a bipolar signal (positive and negative voltage), and for low cost the circuit is powered by a single positive supply. Since negative voltages can therefore not be amplified by the operational amplifier U4, then the ground seen by the operational amplifier U4 must float above the actual circuit ground. The operational amplifier U4 ground is set to the mid-point of the Vref value (P1). This means that the output of the operational amplifier U4 will oscillate around the voltage P1. For example, if the circuit is powered by 2.8V, the Vref value may be 2.5V, and the operational amplifier U4 ground would be 1.25V. After amplification, the sound signal would result in a sine wave that oscillates above and below 1.25V, for example, to 1.45V and 1.05V (see FIG. 12, received signal). Resistor R5 and capacitor C2 are optionally connected to the positive input of operational amplifier U4 to provide a low pass filter between the operational amplifier U4 positive input and the floating ground. Alternatively, a voltage reference of 0.5*Vref could be used to directly drive the positive input of the operational amplifier U4. The capacitor C1 reduces the noise on the floating ground.

It is understood that each receive channel has its own amplifier. The series of amplifiers all share the same floating ground in some embodiments (e.g., divider R3/R4 need not be repeated for each channel).

Most existing acoustic communication systems have extremely complicated and processor intensive circuits. These require high power and expensive digital signal processors and/or field programmable gate arrays. Since cost is a major consideration for commercial viability, it is desirable to decode the acoustic signal using extremely low cost microcontrollers (e.g. those that typically currently retail for under $2 in volume quantities), and that also consume extremely low power, to extend battery life.

In some embodiments, two separate microcontrollers are used. The first microcontroller U3 is used to control the display device, process any input or output commands actuated by the diver, read any depth transducer values, digital compass or control other peripherals or operations as might be expected in a typical decompression diving computer. A second microcontroller U2 is dedicated entirely to decoding the acoustic signals.

As technology advances, another embodiment combines U3 and U2 into a single microcontroller, with sufficient processing power to decode the acoustic signals as well as operate the display device and other peripherals.

In circuit 250A of FIG. 14, the output of the operational amplifier is fed directly into the microcontroller U2. The microcontroller U2 digitizes the signal with its own internal A/D converter. Up to four transducers each with their own op-amps are connected directly to the microcontroller.

In circuit 250B of FIG. 15, a separate external ND converter is used. Each op-amp feeds into this external A/D converter, which then digitizes each signal independently and the digital data is then fed into the microcontroller for further processing. This arrangement can sometimes lower the cost of the system, since standalone high frequency A/D converters are inexpensive compared to microcontrollers with internal high speed ND converters.

In circuit 250C of FIG. 16, the output of each op-amp, in addition to being fed into an ND converter (as in circuits 250A, 250B) is also fed into an analog comparator. The analog comparator has four output channels and will output a ‘1’ when the incoming signal exceeds a preset amplitude. The 0/1 signal from each comparator is fed into a timer capture/compare input pin on the microcontroller. The microcontroller runs a very high speed timer (running at hundreds of kilohertz to several megahertz). This allows the microcontroller to essential timestamp the moment when each comparator switches from 0 to 1. When the acoustic signals strikes the different transducers at different times, each comparator will switch from 0 to 1 at a different time. The microcontroller can then calculate the time difference between each channel, allowing the direction to the signal source to be calculated and shown on the display device.

### Packet Decode Sequence

The primary function of certain embodiments of the invention is long range transmission of tank pressure data. Some embodiments also have a secondary function of locating the source of signal transmission. In the simplest embodiment, the receiver device is capable only of receiving and decoding the tank pressure data transmission, and is incapable of detecting the direction of the signal source. In another embodiment, the device is capable of receiving and decoding the tank pressure transmission, and also calculating the direction of the signal source. In that embodiment, the receiving electronics and processing are more complicated.

In all embodiments the received acoustic signal(s) from the receiving transducer(s) are digitized by an analog to digital converter, either internal to the microcontroller (circuit 250A) or external to it (circuit 250B). Decoding the tank pressure transmission requires an A/D sampling rate of approximately two to three times the frequency of the acoustic signal. For example, if the acoustic signal has a frequency of 40 KHz, then decoding the tank pressure transmission requires an A/D sampling rate of approximately 100 KHz (100,000 samples per second).

Requirements for the sampling rate of the ND converter are different if the signal source direction is to be calculated. Referring to FIG. 6, if receiving transducers X1 and X3 are spaced 40 mm apart, then an acoustic pressure wave traveling left along the X1-X3 axis would strike transducer X3 first, and strike transducer X1 sometime later. Given that the speed of sound in water is approximately 1500 m/s, then the acoustic wave would strike transducer X1 approximately 0.040 m/1500 m/s=26.7 us after it strikes transducer X3. Based on the incoming angle of the acoustic wave, the time differential between striking X1 and X3 will be less than or equal to 26.7 us (in the case of 40 mm transducer separation). In order to resolve the source angle of the incoming signal with reasonable accuracy, the A/D converter must be able to sample the signal fast enough to resolve such miniscule time differences. The faster the ND converter, the greater the accuracy in calculating the source angle, and the higher the cost of the system. In this example, an A/D converter speed of approximately eight times faster than the maximum time difference of 26.7 us will give acceptable resolution. Thus, the ND converter must sample each input signal once every 26.7/8=3.33 us. This corresponds to a sampling rate of just over 300,000 samples per second, per channel. Typically a microcontroller or external device contains a single ND converter with multiplexed inputs. In that case, with three receiving transducers and thus three channels to sample, the ND converter would need to be capable of 900,000 samples per second or more, switching sequentially between each of the three channels, effectively sampling each channel at 300,000 samples per second.

The required sampling rate of the ND converter to resolve the direction of the incoming signal is a function only of the separation between the receiving transducers and the speed of sound in water. It is not a function of the frequency of the sound signal. Conversely, decoding the tank pressure data within the sound signal requires an A/D sampling frequency related to the frequency of the sound signal.

The amplitude of sound waves traveling underwater diminishes with distance. Therefore, if the separation between the transmitter and receiver is large, the received signal will be of much lower electrical amplitude than if the receiver and transmitter are close. Referring to FIG. 12, notice that within the received signal, during periods R1, R3 and R5, noise exists in the received signal even during periods of acoustic silence. This noise may be caused by random noise underwater (caused by bubbles, objects striking each other, or something else). Further, there is inherent electrical noise in the amplification circuit. In FIG. 12, periods R2, R4 and R6 correspond to ‘1’ bits, where acoustic activity exists in the interval of interest. The amplitude of this activity will vary greatly based on the distance from the transmitter to the receiver. Since the receiver device is ignorant of this distance, the ‘1’ bits will have an unknown amplitude. Further, the ‘0’ bits (R1, R3, R5) will have an unknown level of noise amplitude. If the transmitter and receiver are spaced at near maximum range, the amplitude of the electrical activity corresponding to ‘1’ bits will be almost the same as activity corresponding to ‘0’ bits. Some threshold must be determined to differentiate a ‘0’ bit from ‘1’ bit. The time duration of a single bit is known in advance and pre-programmed into both the transmitter and receiver. It is based on the decay time of the transducer. In earlier examples, a value of 1 ms per bit was used.

The following example will explain the signal processing chain used by the receiver, to decode the tank pressure signal and simultaneously compute the source direction of the signal. This example assumes that the A/D converter is operating on three channels (for three transducers) at 300,000 samples per second per channel.

The receiver knows that each signal starts with a ‘start byte’ corresponding to 11010101 in binary. The two initial bits are ‘1’. This means each signal will start with a 2-bit (=2 ms) period of acoustic activity. An experimentally pre-determined threshold is chosen which is just above the average noise level. The receiver A/D converter digitizes each channel continuously. As soon as the value on any channel exceeds the threshold, the possibility of an incoming signal exists. From that point onwards, the receiver is aware that each bit period is 1 ms (for example), and if the A/D converter is operating at 300,000 samples per second per channel, then each bit will correspond to 300 A/D samples (0.001 seconds*300,000 samples/sec). In order to digitize the entire 8-bit ‘start-byte’, the receiver must digitize the signal for a period of 8 bits (=8 ms) (the length of the start byte), corresponding (in this example) to 300 samples per bit*8 bits per start byte=2400 samples per start byte, per channel. Thus, each of the three channels is digitized at full resolution (300,000 samples/sec) for 8 samples, resulting in 2400 samples per channel, times three channels, or 2400*3=7200 samples. An A/D resolution of 8-bits is sufficient (higher resolution can increase the effective range at the expensive of increased cost). At 8-bits, the 7200 samples require 7200 bytes of RAM in the microcontroller. RAM usage must be minimized since additional RAM greatly increases the cost of a microcontroller. In order to minimize RAM usage, the remainder of the signal can be partially decoded in real time, without storing every sample in memory. After the initial 8 bits are digitized (resulting in 2400*3 samples), the system continues to digitize each channel at 300,000 samples per second, but processes every 3rd sample. In the case where the microcontroller has exceptional processing power, every single sample can be processed. In the case where the microcontroller is of lower cost or power, every 3rd sample can be processed. A data stream of 300,000 samples per second, processing every 3rd sample means the microcontroller now processes 100,000 samples per second for each of the three channels, or 300,000 samples per second total. At a typical clock speed of 12 MHz, the microcontroller would have 40 clock cycles (12,000,000 clock cycles per second/300,000 samples per second) to process each sample. The initial start byte (or a portion thereof) is processed at the full A/D frequency to resolve the phase shift between signals with relatively high accuracy; beyond that start byte, the data stream can be processed at a lower frequency, for the sole purpose of decoding the data contained in the stream. This two-frequency approach lowers the cost and complexity of the microcontroller needed to perform the processing, as compared to a single frequency approach.

At 100,000 samples per second, each 1 ms bit corresponds to 100 samples. Due to the floating ground of the amplifier, the ‘zero level’ of the input signal sits at ½ the full range of the A/D converter. If the A/D converter is 8-bits, the conversion result is a number from 0 to 255. A period of acoustic silence would result in an average A/D value of 127, halfway in the range. For each bit (100 samples), the microcontroller computes a value representative of the signal level, which may be calculated according to one of the following equations:

Variance(bit n)=( 1/100)*Sum(from i=1 to 100)of [Sn(i)−127]̂2 Equation 1

Or

Absolute difference(bit n)=( 1/100)*Sum(from i=1 to 100)of |Sn(i)−127| Equation 2

Where the signal over bit n contains one hundred samples from Sn(0) to Sn(100).

(The variance calculation requires a multiplication, which is more processing intensive. In the case of a weak microcontroller, the absolute difference can be used instead, though it produces an inferior signal to noise ratio).

This value will be very large in the presence of acoustic activity, and very small in the case of no activity or noise. This sum is normalized to a number 16-bits in length, and stored in RAM for each bit of the sequence. If a 56-bit packet is used, the first 8 bits were stored at high frequency, and the remaining 48 bits are stored each as a 16-bit sum. This requires 2 bytes per sonic bit×48 bits=96 bytes of RAM for each channel, or 288 bytes of RAM combined for the three channels. With the previous requirement of 7200 bytes for the high resolution start bytes, the total RAM required by the algorithm is 7488 bytes. In some embodiments only the first sonic bit of the start byte is digitized at a high resolution, further reducing the amount of RAM required.

Once the packet (56-bits=56 ms) has been digitized, final decoding occurs. It is important that final decoding is done as fast as possible, since during this time the microcontroller is ‘busy’ and unable to process any further incoming sound signals.

Firstly, the high resolution record of the first 8 bits is analyzed. These 2400 samples (per channel) will each look very similar to the ‘received signal’ in FIG. 12. To match the data frequency of the rest of the signal, these 2400 samples are sub-sampled, and only every 3rd sample is used (800 samples).

For each of the last 6-bits in the start byte (regions R1-R6 in FIG. 12), one of the above formulas is applied (Equation 1 or 2) to determine a value representative of the signal level. In the following description a variance calculation is referred to, but an absolute difference equation could also be used.

The average of the three zero bits (R1, R3, R5) is taken:

Var-Low=Zero bit average variance=(Var(R1)+Var(R3)+Var(R5))/3

The average of the three ‘1’ bits (R2, R4, R6) is taken:

Var-High=‘1’ bit average variance=(Var(R2)+Var(R4)+Var(R6))/3

This provides the average expected variance of a region of acoustic silence, and the average variance of a region of acoustic activity. The digital threshold, or definition of the difference between acoustic silence and acoustic activity, is defined as halfway between Var-Low and Var-High:

Acoustic Threshold=(Var-Low+Var-High)/2

Any bit period with a variance higher than the acoustic threshold is assumed to be ‘1’ bit. Any bit period with a variance lower than the acoustic threshold is assumed to be a ‘0’ bit.

Now, with the threshold known, each channel can be decoded. Channel 0 would now consist of 48 bytes each storing the variance for one bit in the sequence:

Variance for each bit period

Ch0[bit 0]=4389

Ch0[bit 1]=4890

Ch0[bit 2]=14234

Ch0[bit 3]=11203

. . .

Ch0[bit 47]=5089

If the threshold is 8000, then from this sequence we convert the above into bits by threshold comparison to 8000:

Ch0[bit 0]=0

Ch0[bit 1]=0

Ch0[bit 2]=1

Ch0[bit 3]=1

. . .

Ch0[bit 47]=0

The threshold is applied to each of the three signals to convert the list of variances to a list of bits. This results in a 48-bit packet for each channel (the 56-bit packet, without the start byte).

Now, each channel's packet can be decoded. Referring to the packet format at the top of FIG. 12, the final 6-bits are checked against the known ‘end byte’. They must match. The transmitter link code is extracted; the tank pressure value is extracted; the battery level is extracted. Finally, the 10-bit checksum of the link code, tank pressure and battery data is calculated, and compared against the checksum within the packet. If it matches, the packet is considered valid.

The decoding process is repeated for each of the three channels. It is possible that one channel had corrupted data and another one uncorrupted.

Note that the phase shift between the signals is so small that despite assuming the same starting reference point for each channel, the phase shift has a negligible effect on the packet decoding.

### Signal Source Direction Calculation

In some embodiments, direction of the signal source is also calculated. The signal source direction calculation may be based on the three high resolution buffers digitized at the start of each channel (at the full sampling rate of 300,000 samples per second).

The phase shift between these three signals may be calculated by a variety of methods, depending on the available processing power of the microcontroller. If significant processing power is available, the signals can be convolved or correlated with each other to solve for the phase shift. If less processing power is available, the locations of the maxima of the sine wave can be calculated for each wave, and the locations of these maxima compared between the channels. The resulting phase shift is in number of discrete A/D samples. For example, channel 1 may be the earliest channel, channel 0 may be six samples delayed from channel 1, and channel 2 could be four samples delayed from channel 0. Delays expressed in samples are converted to time delays by the sampling frequency of the ND converter. The time delays are then used along with the transducer separation geometry to compute the angle of the source signal. The angle and/or an indication thereof (e.g. an arrow) can then be displayed on the display device.

Since the acoustic signal from the transmitter may be transmitted only once every several seconds, the angle displayed on the display device would only be updated once every few seconds. A faster update rate can be achieved if the receiver device has a digital compass as well. At the moment the angle to the source signal is calculated, it can be converted into a compass bearing. Then, the display device can update the directional arrow many times per second based on the compass bearing. Several seconds later when the next acoustic signal is received, an updated bearing is calculated, and the displayed arrow is again based on that compass bearing until the next acoustic signal is received. In this fashion the user sees an arrow which updates rapidly and continuously, even though the acoustic bearing is only updated once every few seconds.

Referring to circuit 250C of FIG. 16, an alternate method can be used to calculate the phase shift. In this embodiment, three analog comparators are used, each configured for the same acoustic threshold value. The comparators will trip from 0 to 1 at slightly different times as the acoustic wave strikes each of the several transducers at different times. The microcontroller, using a high speed timer with a capture function, can capture the timestamp of the 0->1 transition for each comparator. This method is simple and less expensive because the A/D converter is used only to decode the signal data, meaning the A/D converter can be (in most cases) a lower speed and lower cost one. The disadvantage of the comparator method is that the phase shift between signals will be more subject to noise, and may be either more noisy, less accurate, or both.

In order to calculate the angle to the source signal, several receiver transducers are needed. If four receiver transducers are used, the direction to the source can be calculated in 3 dimensions. If three receiver transducers are used that are in a plane parallel with the plane with the display device, then the user must hold the display device parallel to the ocean floor to get an accurate directional arrow.

If only two receiver transducers are used (X1 and X3 in FIG. 6, without X2), the user must hold the display device parallel to the ocean floor, and there is ambiguity in the source signal direction. Any time delay between the signal striking the two sensors can imply the signal is coming from one of two possible directions. Two arrows would be displayed on the display device. The user would need to slowly rotate the display device (keeping it parallel to the ocean floor), and during this gradual rotation, once the signal source wave is striking the device along the X3-X1 axis (as shown in FIG. 6) then the ambiguity is resolved and the two arrows would converge into a single arrow.

A transmitter device similar to those as disclosed herein can also be suspended under a dive boat or mounted at a semi-permanent underwater location, allowing any diver underwater to locate the boat or the location. Such a device would not need any pressure transducer, and would not need to be attachable to a tank.

If, for example, 10 divers are in the water, then a receiver device as disclosed herein could monitor the diver's own tank, and the tanks of nine other people. In this case, tank pressure data from all nine divers could be displayed on the display device simultaneously, and nine separate arrows indicating the direction of those nine divers could be displayed simultaneously.

As one skilled in the art will appreciate, numerous combinations, subcombinations and variations of the features of the example embodiments described above are possible in other embodiments. For example, in some embodiments, the generally cylindrical portions of the housing could be “inverted” such that the ring transducer is at or near the bottom of the transmitter device. In some embodiments, the housing of the transmitter device may have a greater effective diameter farther away from the connector and still provide the required clearance for direct connection to a first stage regulator, but as one skilled in the art will appreciate, the housing should be shaped so as not to protrude from the regulator in a dangerous fashion. In some embodiments, different types of acoustic transducers may be used in the transmitting device, such as, for example, a plurality of directional piezo benders aiming in different directions, although such an arrangement may require a larger and/or more complexly shaped housing than desirable.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. An apparatus comprising:
a housing having a connector configured to connect to a first stage regulator, the housing having a size and shape configured to provide clearance for one or more hoses connected to the first stage regulator;
a pressure sensor within the housing, the pressure sensor coupled to receive a measured pressure through the connector and configured to generate a pressure indication based on the measured pressure;
a transducer within the housing, the transducer configured to convert electrical signals into vibration signals;
a power pack within the housing, the power pack configured to connect across a battery to receive a battery voltage, the power pack comprising at least one excitation capacitor selectively connectable to the transducer and configured to provide an excitation voltage to the transducer, the excitation voltage being significantly higher than the battery voltage; and
a controller connected to receive the pressure indication from the pressure sensor and control the power pack to charge the at least one excitation capacitor and discharge the at least one excitation capacitor to provide excitation pulses to the transducer, the excitation pulses configured to cause the transducer to generate a sonic data packet based on the pressure indication.

2. An apparatus according to claim 1, wherein:
the housing has a first generally cylindrical portion of a first diameter and a second generally cylindrical portion of a second diameter larger than the first diameter, the first and second generally cylindrical portions being nonconcentric with each other;
a generally cylindrical battery compartment is disposed within the housing and extending through at least a portion of each of the first and second generally cylindrical portions of the housing;
the transducer is positioned in the first generally cylindrical portion of the housing; and,
the power pack is positioned in the second generally cylindrical portion.

3. An apparatus according to claim 1 wherein the power pack comprises at least one high voltage capacitor.

4. An apparatus according to claim 3 wherein the power pack comprises an inductor connectable under control of the controller to receive the battery voltage and provide a high voltage charging current to the at least one high voltage capacitor.

5. An apparatus according to claim 2 wherein the power pack comprises at least one high voltage capacitor, and an inductor connectable under control of the controller to receive the battery voltage and provide a high voltage charging current to the at least one high voltage capacitor.

6. An apparatus according to claim 1 wherein the power pack comprises at least one supercapacitor connected in parallel with the battery.

7. An apparatus according to claim 2 wherein the transducer comprises a ring transducer positioned around an outside of the generally cylindrical battery compartment

8. An apparatus according to claim 1 wherein the controller controls the transducer to generate a plurality of sonic data packets with a time between sonic data packets being significantly longer than a duration of each of the plurality of sonic data packets.

9. An apparatus according to claim 8 wherein the duration of each of the plurality of sonic data packets is less than about 0.1 seconds and the time between sonic data packets is at least about 2 seconds.

10. An apparatus according to claim 8 wherein each sonic data packet comprises a plurality of binary sonic bits, wherein the controller is configured to represent a ‘1’ bit by controlling the transducer to generate a short acoustic signal and to represent a ‘0’ bit with a period of acoustic silence.

11. An apparatus according to claim 8 wherein the controller randomizes the time between sonic data packets.

12. An apparatus according to claim 1, wherein:
the power pack comprises an inductor connected at a first end thereof to receive the battery voltage, and at least one high voltage capacitor having a first side connected to a second end of the inductor through a diode rectifier and a second side connected to ground; and
the controller comprises a first transistor connected between the second end of the inductor and ground such that when the path from the inductor to ground is closed electrical energy from the battery is stored as a magnetic field in the inductor and when the path from the inductor to ground is open the magnetic field collapses and current flows through the diode rectifier to charge the at least one high voltage capacitor.

13. An apparatus according to claim 12 wherein the transducer is connected between the first side of the at least one high voltage capacitor and ground the controller comprises a second transistor connected between the first side of the at least one high voltage capacitor and ground.

14. A method for monitoring a group of divers, the method comprising:
providing a plurality of transmitter devices, each transmitter device connected to receive a tank pressure from a first stage regulator of one diver of the group of divers, each transmitter device comprising a transmitting transducer configured to generate acoustic signals at a transmitting frequency;
providing a receiver device comprising at least one receiving transducer configured to detect acoustic signals having the transmitting frequency;
at each of the transmitter devices, generating a plurality of sonic data packets with a time between sonic data packets being significantly longer than a duration of each of the plurality of sonic data packets, each sonic data packet comprising at least an identification portion and a pressure indicating portion;
at the receiver device, receiving the sonic data packets and determining a remaining air supply for each diver of the group of divers.

15. A method according to claim 14 wherein each sonic data packet comprises a plurality of binary sonic bits, the method comprising representing a ‘1’ bit by controlling the transducer to generate a short acoustic signal and representing a ‘0’ bit with a period of acoustic silence.

16. A method according to claim 14 comprising randomizing the time between sonic data packets.

17. A method according to claim 14 wherein the receiver device comprises a plurality of receiving transducers, the method comprising determining a direction of one of the transmitter devices based on a time of receipt of the sonic data packet from that transmitter device at each of the plurality of transducers and a known spatial relationship among the plurality of transducers.

18. A method according to claim 14 wherein each transmitter device is configured to transmit and not receive acoustic signals and each receiver device is configured to receive and not transmit acoustic signals.

19. A method according to claim 14 wherein receiving the sonic data packets comprises sampling the receiving transducer at a rate of at least two times the transmitting frequency.

20. A method according to claim 15 wherein the receiver device detects acoustic signals by sampling the receiving transducer to obtain a plurality of signal samples, determining a signal sample difference between each of the signal samples and a halfway point of an input signal range, summing one of a square and an absolute value of each signal sample difference to obtain a summed difference value, and dividing the summed difference value by a number of the plurality of samples.
